(19) United States
(12) Patent Application Publication
(10) Pub. No.: US 2009/0135199 A1
(43) Pub. Date: May 28, 2009

(54) DISPLAY SYSTEM, DISPLAY SYSTEM DISPLAY CONTROL METHOD, DATA DISPLAY PROGRAM, AND RECORDING MEDIUM

(75) Inventor: Toshiya OKAMOTO, Soraku-gun (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/296,549

(22) PCT Filed: Nov. 22, 2006
(86) PCT No.: PCT/JP2006/323304

§ 371 Date: Oct. 9, 2008

(30) Foreign Application Priority Data
Apr. 13, 2006 (JP) 2006-111291

(51) Int. Cl. G09G 5/00

(52) U.S. Cl. 345/619

(57) ABSTRACT

A display system provided in a drivable vehicle is arranged to display information including the information on the vehicle on the screens corresponding to the information, on a front liquid crystal panel and a rear liquid crystal panel. The liquid crystal panels can each display data at least one screen. The system has first and second control circuits provided for the respective front and rear liquid crystal panels and adapted to create display data to be displayed on the screens of the front and rear liquid crystal panels, and a single all-panel control section arranged to select screens displayed on the front and rear liquid crystal panels according to the information including the information on the vehicle. When display panels are equipped in a moving body, a display system is capable of controlling the screen display of the display panels integrally. A display system display control method, a data display program and recording medium are also displayed.

### BACKGROUND OF THE INVENTION

1. Field of the Invention

The present invention relates to a display system for use in a maneuverable movable product and for displaying plural pieces of information respectively on screens of plural display panels which respectively correspond to the plural pieces of information, wherein information regarding the movable product is included among the plural pieces of information, a display control method for the display system, data display program, and recording medium.

2. Description of the Related Art

A display system for use in an instrument panel for an automobile is disclosed in Japanese Patent Application Publication, Tokukaihei No. 9-123848. The display system is, as illustrated in FIG. 6, connected with an information processing device 102 via an image processing device 101 including a VRAM or the like. The information processing device 102 includes (i) a CPU for performing certain operations via an image processing device 101 including a VRAM or the like, (ii) a ROM storing a processing program therein, and (iii) an I/O interface. The information processing device 102 receives various information from a navigation system 103, a traffic information communication system 104, a monitor system 105, a sensor system 106, and a diagnosis system 107. The information processing device 102 judges a driving state based on the various information, and acquires necessary information and displays, via the display processing device 101, various information items on a wide display device 108 having plural screens.

It is a premise in the display system that only one wide display device 108, which is a display panel, is provided. Meanwhile more automobiles are equipped with car navigation systems. Such automobiles may be equipped with plural display panels, for example, such that a display panel for television is provided for rear seats in addition to a display panel provided on an instrument panel or the like for front seats.

In such automobiles equipped with plural display panels, a front display panel control section 112 and a rear display panel control section 122, each of which is an independent controller, are provided for a front display panel 111 and a rear display panel 121, respectively. The front display panel control section 112 and the rear display panel control section 122 output composite images to the front display panel 111 and rear display panel 121, respectively.

However, the conventional display system has such problems that it requires the controllers respectively for the front display panel 111 and rear display panel 121, and that the controllers are independent of each other and have a difficulty to control integrally.

Specifically, such a conventional display system is, for example, arranged such that the front display panel 111 has a display screen for meters of the automobile, and a navigation screen, while the rear display panel 121 has a TV screen, it is not possible to display the navigation screen on the rear display panel 121.

### SUMMARY OF THE INVENTION

In order to overcome the problems described above, preferred embodiments of the present invention provide a display system in which screen display operations of plural display panels can be controlled integrally, a display control method of the display system, a data display program, and a recording medium.

A display system according to a preferred embodiment of the present invention is a display system for use in a maneuverable movable product and for displaying plural pieces of information respectively on those screens of plural display panels which respectively correspond to the plural pieces of information, wherein information regarding the movable product is included among the plural pieces of information, wherein each display panel arranged to display at least one screen, and the display system includes: a display screen control section for each display panel, arranged to generate display data of the at least one screen of the display panel; and a display selecting section arranged to select screens to be displayed respectively on the display panels, the selecting being carried out based on the plural pieces of information among which the information regarding the movable product is included.

A display control method according to a preferred embodiment of the present invention is a display control method for a display system for use in a maneuverable movable product and for displaying plural pieces of information respectively on those screens of plural display panels which respectively correspond to the plural pieces of information, wherein information regarding the movable product is included among the plural pieces of information, the display control method including the steps of: causing the display panels each to display at least one screen thereon; selecting the at least one screen to be displayed respectively on each display panel, the selecting being carried out based on plural pieces of information among which the information regarding the movable product is included; and controlling the screens of the display panels, the step of controlling including generating display data of the at least one screen of each display panel.

The maneuverable movable product may be a vehicle such as an automobile, a train, an airplane, a vessel, for example, or other suitable vehicles or transportation apparatuses and equipment.

According to a preferred embodiment of the present invention, the display system is mounted in the maneuverable movable product, and displays the plural pieces of information on corresponding screens on the plural display panels, where among the plural pieces of information, the information regarding the maneuverable movable product is included. In a preferred embodiment of the present invention, the plural display panels are, for example, a front display panel provided at a front portion of a vehicle, and a rear display panel provided at a rear portion of the vehicle.

In a preferred embodiment of the present invention, each display panel is capable of displaying at least one screen. Thus, each display panel may display one screen or plural screens. Therefore, it is possible to display plural screens such as a screen regarding speed and a navigation screen on one display panel.

Conventionally, there is no display system provided with plural display panels whose screen displays are controlled integrally. Therefore, the display devices are provided independently, so that a screen cannot be displayed on a desired one of the display devices instantly. For example, in the event of braking suddenly, it is desirable to display emergency stopping display on a display device displaying a meter and on a display device displaying a navigation screen. However, these display devices do not operate in synchronism. Therefore, there would be a time lag in displaying the emergency stopping display.

In order to solve this problem, a preferred embodiment of the present invention is arranged such that a single display selecting section arranged to select screens to be displayed respectively on the display panels, the selecting being carried out based on the plural pieces of information among which the information regarding the movable product is included, and that the display screen control section generates display data of the at least one screen of the display panels.

As a result, it is possible to control the display data of each screen on each display panel by the single display selecting section.

Therefore, it is possible to provide a display system and a display control method of the display system, each of which allows integral control of screen displays on plural display panels, which are provided in a movable product.

Moreover, the cost is reduced compared with the conventional art, with the arrangement in which the integral control of screen displays on the plural display panels is performed by the display selecting section that is independently provided.

The display system according to a preferred embodiment of the present invention may be arranged such that the display selecting section includes: a judging section arranged to judge types of the plural pieces of information, among which the information regarding the moving body is included, and to cause the display screen control sections to display and control the at least one screen on the respective display panels; and a screen combination pattern storing section arranged to store patterns of combinations of the screens of the display panels.

In this arrangement, the judging section judges the types of the plural information among which the information regarding the movable product is included. The screen combination pattern storing section stores patterns of combinations of the screens of the display panels. Based on the stored patterns of combinations of the screens of the display panels, the judging section causes the display screen control sections to perform the display control on at least one screen on the display panels, respectively.

As a result, the judging section and the screen combination pattern storing section can easily attain integral control of the screen display of the plural display panels.

The display system according to a preferred embodiment of the present invention is preferably arranged such that the screen combination pattern storing section stores a pattern for displaying plural pieces of information on screens of the display panels concurrently, wherein the information regarding the movable product is included among the plural pieces of information.

With this arrangement, it is possible to display the screens of different content on the plural display panels concurrently.

The display system according to a preferred embodiment of the present invention is preferably arranged such that, as the patterns of the combinations of the screens of the display panels, the screen combination pattern storing section stores patterns regarding types, sizes, and locations of the screens of the display panels.

With this unique arrangement, it is possible to display the screens different in type, size, and location on the display panels.

Moreover, the display system according to a preferred embodiment of the present invention may be arranged such that the maneuverable movable product is a vehicle.

It is possible to provide a display system, which allows integral control of screen displays on the plural panels, which are provided in a vehicle.

The display system according to a preferred embodiment of the present invention may be arranged such that the information regarding the movable product is vehicle information, such as power train-related information regarding speed, engine, gear, body-related information, etc. regarding door, lights, air conditioner, etc.

With this, the vehicle information, which is essential information for the vehicle, can be displayed on at least one screen on at least one of the display panels.

The display system according to a preferred embodiment of the present invention may be arranged such that multimedia information is included among the plural pieces of information among which the information regarding the movable product is included.

With this, the multimedia information can be displayed on at least one screen on at least one of the display panels.

Moreover, the display system according to a preferred embodiment of the present invention may be arranged such that amenity information and safety information are included among the multimedia information, wherein the amenity information is additional information for supporting a maneuver of the movable product and may be map information or the like information, and safety information is information for improving safety of the maneuver and may be information obtained from a blind spot sensor or the like information.

The amenity information such as TV and navigation for example and images for safe driving, such as images of the front CCD camera, rear CCD camera, etc., has been displayed recently in vehicles. With the arrangement described above, such amenity information and information regarding safety can be displayed on at least one screen on at least one of the display panels.

A data display program according to a preferred embodiment of the present invention is a data display program for operating the display system described above, wherein the data display program causes a computer to function as each of the sections described above.

In a preferred embodiment of the present invention, each element or section of the display system may preferably be realized by using a computer such as LSI or the like that can execute the program by using hardware.

A computer-readable recording medium according to another preferred embodiment of the present invention is a computer-readable recording medium on which the data display program is stored.

According to a preferred embodiment of the present invention, with the data display program read out from the recording medium, the display system can be realized on a computer such as LSI or the like which can execute the program by using a hardware.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a preferred embodiment of a display system according to the present invention.

FIG. 2 is a block diagram illustrating a whole configuration of one liquid crystal panel in the display system.

FIG. 3 is a schematic view illustrating a screen configuration of the liquid crystal panel when a vehicle is driving, stopping, and reversing.

FIG. 4 is a schematic view illustrating various display patterns, under legends (a) to (f), of a front liquid crystal panel and a rear liquid crystal panel of the display system.

FIG. 5 is a flow chart illustrating display control of the display patterns of the front liquid crystal panel and the rear liquid crystal panel of the display system.

FIG. 6 is a block diagram illustrating a conventional display system.

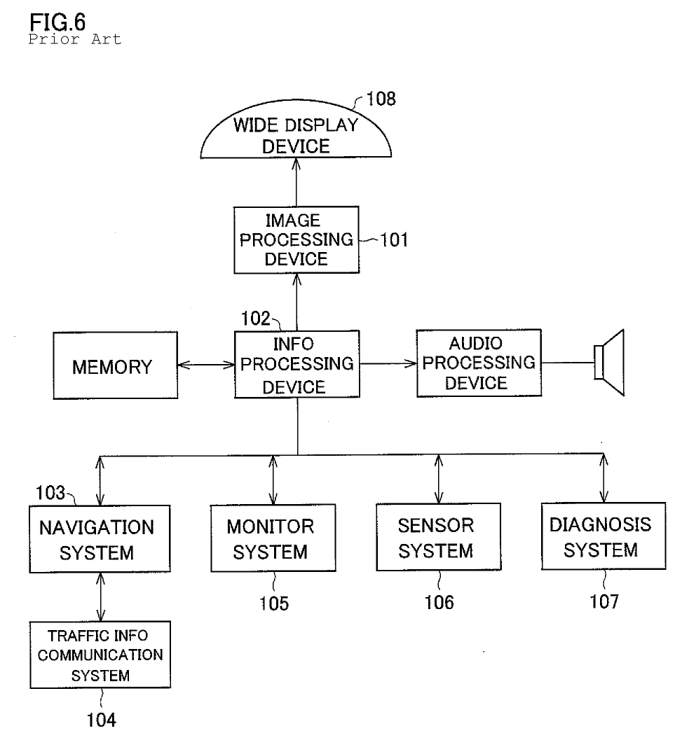

FIG. 7 is a block diagram illustrating display control of the conventional display system.

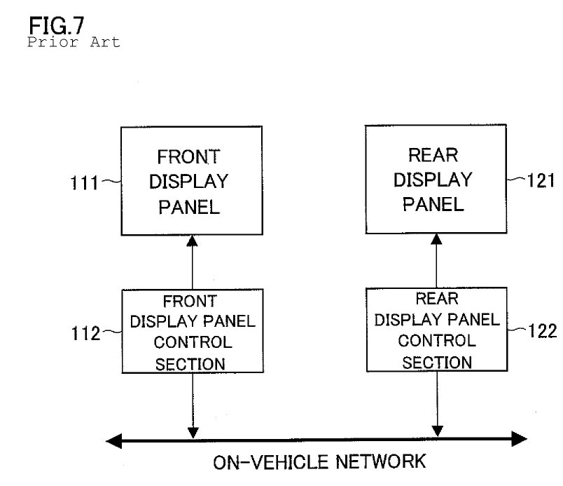

### DETAILED DESCRIPTION OF THE PREFERRED EMBODIMENTS

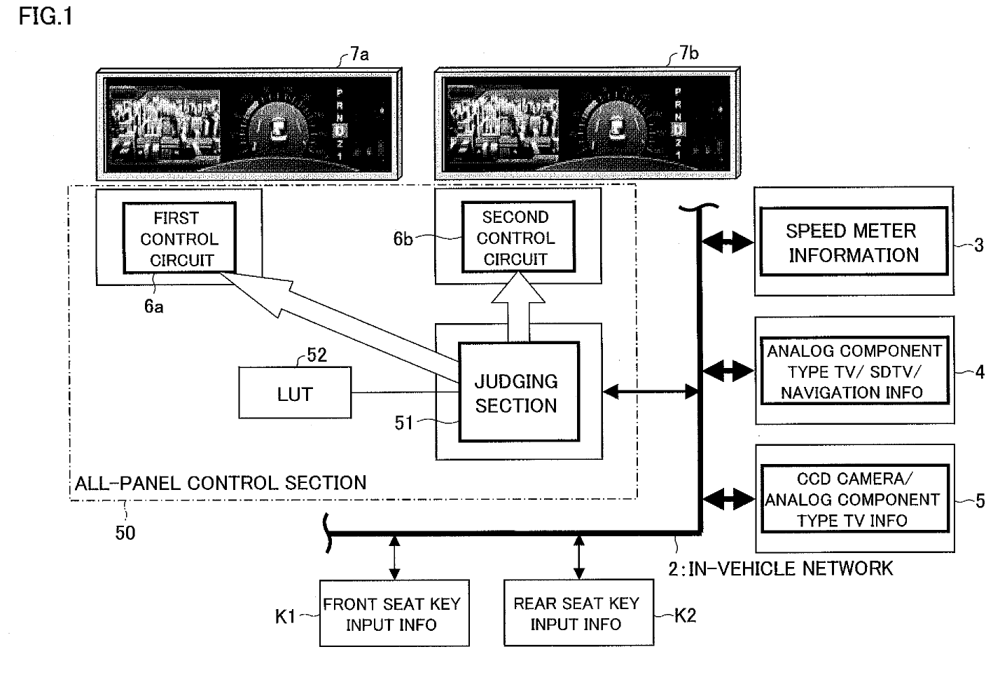

Preferred embodiments of the present invention are described below with reference to FIGS. 1 to 5.

A display system according to the present preferred embodiment includes, as illustrated in FIG. 1, a front liquid crystal panel 7a, a rear liquid crystal panel 7b, an all-panel control section 50 (display selecting section), and an in-vehicle network 2. The front liquid crystal panel 7a, and the rear liquid crystal panel 7b are display panels.

The in-vehicle network 2 is connected with a vehicle system 3 arranged to supply speedometer information, an amenity system 4 arranged to supply information regarding analog component type TV/digital TV (SDTV (Single Definition TV)/navigation device, etc., which can output a component signal for high definition display, a safety system 5 arranged to supply information regarding a CCD camera/analog composite type TV, etc., a front seat key input K1 arranged to supply front seat key input information, and a rear seat key input K2 arranged to supply rear seat key input information. The speedometer information corresponds to information of a movable product in a preferred embodiment of the present invention. The information regarding analog component type TV/digital TV (SDTV (Single Definition TV)/navigation device, etc., information regarding a CCD camera/analog composite type TV, etc., front seat key input information, and the rear seat key input information correspond to plural pieces of information in a preferred embodiment of the present invention.

That is, the display system according to the present preferred embodiment includes, for example, two display devices, namely, the front liquid crystal panel 7a and the rear liquid crystal panel 7b. By controlling the front liquid crystal panel 7a and the rear liquid crystal panel 7b by using the single all-panel control section 50, the display system can be manufactured at a low cost and can allow the plural display panels to display in synchronism. The present invention is not limited to the present preferred embodiment in which two display devices are provided, and may include more display devices.

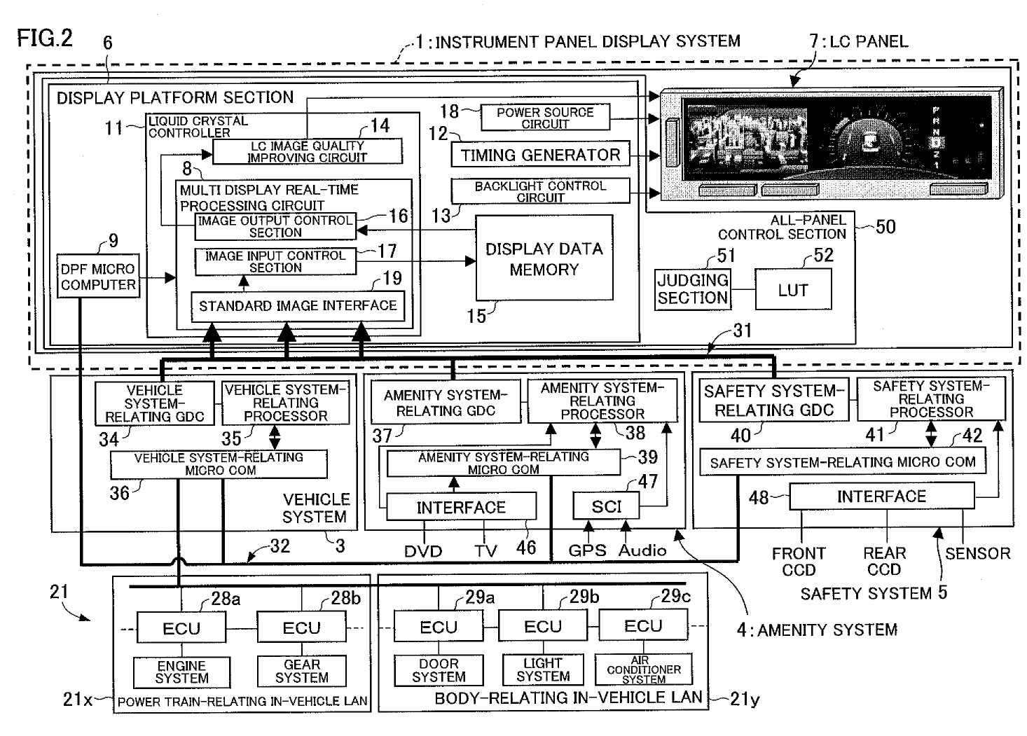

Individual display systems of the front liquid crystal panel 7a and the rear liquid crystal panel 7b in the present preferred embodiment are described according to FIG. 2, which is a block diagram illustrating more specifically a control system of a liquid crystal panel 7, which is either of the front liquid crystal panel 7a and the rear liquid crystal panel 7b, in order to illustrate the front liquid crystal panel 7a and the rear liquid crystal panel 7b.

As illustrated in FIG. 2, the display system preferably includes an instrument panel display system 1, an amenity system 4, which is an input/output system for amenity devices such as DVD, TV, GPS, Audio, etc., a safety system 5, which is an input/output system for safety devices such as various CCD, sensors, etc., and vehicle data-transferring in-vehicle LAN 21. The vehicle data-transferring in-vehicle LAN 21 includes a power train-relating in-vehicle LAN 21x and a body-relating in-vehicle LAN 21y. The power train-relating in-vehicle LAN 21x is connected with an electric control unit (ECU) 28a for engine control, and an electric control unit (ECU) 28b for gear control, and the like. Moreover, the body-relating in-vehicle LAN 21y is connected with an electric control unit (ECU) 29a for door control, an electric control unit (ECU) 29b for light control, an electric control unit (ECU) 29c for air conditioner control, and the like.

The instrument panel display system 1 includes a display platform section 6 and a liquid crystal panel 7. The display platform section 6 includes a display platform micro computer 9 (hereinafter, referred to as “DPF micro computer 9”), a liquid crystal controller 11, a display data memory 15, a power source 18, a timing generator 12, and a backlight control circuit 13. Further, the liquid crystal controller 11 includes a liquid crystal image quality improving circuit 14, and a multiple display real time processing circuit 8. Further, the multiple display real time processing circuit 8 includes an image output control section 16, an image input control section 17, and a standard image interface 19.

The vehicle system 3 includes a vehicle system-relating graphic display controller 34 (hereinafter, referred to as “vehicle system-relating GDC 34”), a vehicle system-relating processor 35, and a vehicle system-relating micro computer 36, which is compatible with the in-vehicle LAN. The amenity system 4 includes an amenity system-relating graphic display controller 37 (hereinafter, referred to as “amenity system-relating GDC 37”), an amenity system-relating processor 38, and an amenity system-relating micro computer 39, which is compatible with the in-vehicle LAN. Moreover, the safety system 5 includes a safety system-relating graphic display controller 40 (hereinafter, referred to as “safety system-relating GDC 40”), a safety system-relating processor 41, and a safety system-relating micro computer 42, which is compatible with the in-vehicle LAN.

The vehicle system micro computer 36 is connected with the vehicle data-transferring in-vehicle LAN 21. Moreover, connected with the display control data-transferring in-vehicle LAN 32 are the DPF micro computer 9 of the display platform section 6, the vehicle system-relating micro computer 36 of the vehicle system 3, the amenity system-relating micro computer 39 of the amenity system 4, and the safety system-relating micro computer 42 of the safety system 5. The display control data-transferring in-vehicle LAN 32 is an in-vehicle LAN such as CAN, LIN, for example, and functions as a pathway for communicating, in a prescribed format(s), image output control data and image layout data for controlling image displaying.

Moreover, connected with the image data-transferring in-vehicle LAN 31 are the vehicle system-relating GDC 34, the amenity system-relating GDC 37, the safety system-relating GDC 40, and the standard image interface 19 of the display platform section 6. The image data transferring in-vehicle LAN 31 is a high-speed LAN such as MOST, IDB1394, for example, and functions as a pathway for connecting the display platform section 6 with the GDCs 34, 37, and 40 of the respective systems via a connector(s). The image data transferring in-vehicle LAN 31 may be replaced with exclusive lines for connecting the display platform section 6 with the GDCs 34, 37, and 40, individually.

In the following, the sections of the vehicle data-transferring in-vehicle LAN 21, the vehicle system 3, the amenity system 4, the safety system 5, and the instrument panel display system 1 are described.

The power train-relating in-vehicle LAN 21x of the vehicle data-transferring vehicle LAN 21 is connected with the ECU 28a for an engine, ECU 28b for gears, and the like. The ECU 28a for the engine performs the engine control, transmission of numerical data regarding the engine, reception of control data from another ECU, and the other operation. The ECU 28b for the gears performs the gear control, transmission of numerical data regarding the gears, reception of control data from another ECU, and other operations. The power train-relating LAN 21x sends, as the vehicle data, data regarding warning information, blinker, speed, and revolution to the vehicle system-relating micro computer 36 of the vehicle system 3. The data regarding the revolution is for example real-time data that should be transmitted in real time and have high reliability.

The body-relating in-vehicle LAN 21y of the vehicle data-transferring in-vehicle LAN 21 is connected with the ECU 29a for doors, the ECU 29b for lights, and ECU 29c for air conditioner, and the like. The ECU 29a for the doors performs transmission of open/close signals of the doors, reception of control data from another ECU, and the other operation. The ECU 29b for the lights performs transmission of ON/OFF signals of the lights, reception of control data from another ECU, and the other operation. Moreover, the ECU 29c for the air conditioner performs the air conditioner control, reception of control data from another ECU, and the other operation. The body-relating in-vehicle LAN 21y transmits, as the vehicle data, data regarding open/close of the doors, lights, air conditioner control, etc. to the vehicle system-relating micro computer 36 of the vehicle system 3. The vehicle data is data that may be transmitted at low speed.

The vehicle system-relating micro computer 36 of the vehicle system 3 is a micro controller having an interface for a LAN (Local Area Network) special for automobile such as CAN, LIN, FlexRay, etc.

The vehicle system-relating micro computer 36 receives various vehicle data (power train-relating or body-relating vehicle data) from the vehicle data-transferring in-vehicle LAN 21, and transmits the received vehicle data to the vehicle system-relating processor 35.

The vehicle system-relating micro computer 36 receives various vehicle data (for example, data regarding driving-forward, stopping, turning-right, turning-left, reversing, driving speed, etc.) from the vehicle data-transferring in-vehicle LAN 21, and transmits the received various vehicle data to the amenity system-relating micro computer 39, the safety system-relating micro computer 42, and the DPF micro computer 9 of the display platform section 6 via the display control data-transferring in-vehicle LAN 32.

Furthermore, the vehicle system-relating micro computer 36 transmits to the display control data-transferring in-vehicle LAN 32 the image layout data and image output control data generated by the vehicle system-relating processor 35.

The vehicle system-relating processor 35 of the vehicle system 3 receives the various vehicle data via the vehicle system-relating micro computer 36, and controls the vehicle system-relating GDC 34 so as to generate image data for an image, for example, data regarding positions or the like of a speedometer, tachometer, shift lever, and the like. Further, the vehicle system-relating processor 35 generates the image layout data for setting sizes, positional relationship, overlapping, etc., and the image output control data for controlling switching-over of the image or layout.

The vehicle system-relating GDC 34 creates a two-dimensional or three-dimensional graphic under command of the vehicle system-relating processor 35, sends image data thus created to the image data-transferring in-vehicle LAN 31.

The amenity system-relating micro computer 39 of the amenity system 4 is a micro controller having an interface for an LAN specialized for automobiles such as CAN, LIN, FlexRay, or the like, for example. The amenity system-relating micro computer 39 receives the vehicle data transmitted from the vehicle system-relating micro computer 36 via the display control data-transferring in-vehicle LAN 32. Then, the amenity system-relating micro computer 39 transmits the received vehicle data to the amenity system-relating processor 38.

Further, the amenity system-relating micro computer 39 transmits to the display control data-transferring in-vehicle LAN 32 the image layout data and the image output control data generated by the amenity system-relating processor 38.

The amenity system-relating processor 38 of the amenity system 4 receives data sent from the DVD or TV via the interface 46, data sent from GPS or Audio via the SCI 47, and the vehicle data sent via the amenity system-relating micro computer 39. Based thereon, the amenity system-relating processor 38 controls the amenity system-relating GDC 37 to generate image data for a navigation image, TV image, DVD image, or the like. The image data for the navigation image is generated by the amenity system-relating processor 38 combining (i) map data from the DVD with (ii) vehicle position information from the GPS.

Further, the amenity system-relating processor 38 generates the image layout data for setting the size, positional relationship, etc., of each image, and the image output control data for controlling the switching-over of the image or layout.

The amenity system-relating GDC 37 creates a two-dimensional or three-dimensional graphic under the command of the amenity system-relating processor 38. Then, the amenity system-relating GDC 37 sends the generated image data to the image data-transferring in-vehicle LAN 31.

The safety system-relating micro computer 42 of the safety system 5 is a micro controller having an interface for a LAN specialized for automobiles such as CAN, LIN, FlexRay, or the like, for example. The safety system-relating micro computer 42 receives the vehicle data from the vehicle system-related micro computer 36 via the display control data-transferring in-vehicle LAN 32. Then, the safety system-relating micro computer 42 transmits the received vehicle data to the safety system-relating processor 41.

The safety system-relating microcomputer 42 sends to the display control data-transferring in-vehicle LAN 32 the screen layout data and the image output control data thus generated by the safety system-relating processor 41.

The safety system-relating processor 41 of the safety system 5 receives data from a front CCD, a rear CCD, and various sensors via the interface 48, and the vehicle data transmitted via the safety system-relating micro computer 42. Based thereon, the safety system-relating processor 41 controls the safety system-relating GDC 40, and generates image data for various CCD images or the like. More specifically, the safety system-relating processor 41 performs safety detection process or the like such as obstacle detection, white line detection, or the like, by using input images of the various CCDs, and generates warning data or the like regarding an obstacle. Furthermore, the safety system-relating processor 41 generates image layout data for setting size, positional relationship, and the like of each image, and image output control data for controlling the switching-over of the image or layout. Here, such a layout is possible that a warning image is displayed to overlap a CCD image.

The safety system-relating GDC 40 creates a two-dimensional or three-dimensional graphic under command of the safety system-relating processor 41, and sends the generated image data to the image data-transferring in-vehicle LAN 31.

The DPF micro computer 9 of the instrument panel display system 1 is a micro controller having an interface specialized for automobiles such as CAN, LIN, FlexRay, or the like, for example. The DPF micro computer 9 receives the image layout data and image output control data via the in-vehicle LAN 32 from the vehicle system-relating micro computer 36, the amenity system-relating micro computer 39, and the safety system-relating micro computer 42. Then, the DPF micro computer 9 inputs the image layout data and image output control data to the multiple display real-time processing circuit 8. Moreover, the DPF micro computer 9 receives the vehicle data from the vehicle system-relating micro computer 36 via the display control data-transferring LAN 32, and inputs the vehicle data to multiple display real-time processing circuit 8.

The liquid crystal panel 7 of the instrument panel display system 1 is a liquid crystal panel module including a driver IC, backlight, and the like. The timing generator 12 generates a signal specific for the liquid crystal panel. The backlight control circuit 13 controls the backlight of the liquid crystal panel 7. The power source circuit 18 provides power source voltage to the liquid crystal panel 7. The display data memory 15 stores/accumulates the image data temporally. Moreover, the display data memory 15 is used as a work area for processing image, or performing another operation.

The liquid crystal controller 11 of the instrument panel display system 1 outputs display data to the liquid crystal panel 7. That is, the multiple display real-time processing circuit 8 generates the display data, based on (i) the image data and layout data generated by the vehicle system 3, amenity system 4, or the safety system 5, and (ii) screen layout information that is set in advance. Furthermore, the liquid crystal image quality improving circuit 14 optimizes the display data according to properties of the liquid crystal panel 7, and output the optimized display data to the liquid crystal panel 7.

The sections of the multiple display real-time processing circuit 8 are described further in the following.

The standard image interface 19 receives image data via an LAN for image data, such as MOST, IDB 1394, or via an exclusive line such as LVDS, DVI, HDMI, or the like. Moreover, into a prescribed area in the display data memory according to the screen layout data inputted from the DPF micro computer 9, the image input control section 17 writes various image data inputted via the standard image interface 19.

The image output control section 16 reads the image data from the display data memory 15, and generates the display data for displaying each image on the liquid crystal panel 7 concurrently according to the screen layout data inputted from the DPF micro computer 9. The display data is outputted to the liquid crystal panel 7 via the liquid crystal image quality improving circuit 14. In this way, the image generated by the vehicle system 3, the amenity system 4, or the safety system 5 is displayed on a predetermined position on the liquid crystal panel 7 (that is, a position prescribed by the screen layout information) in a layout generated by the respective systems according to a driving state of the vehicle.

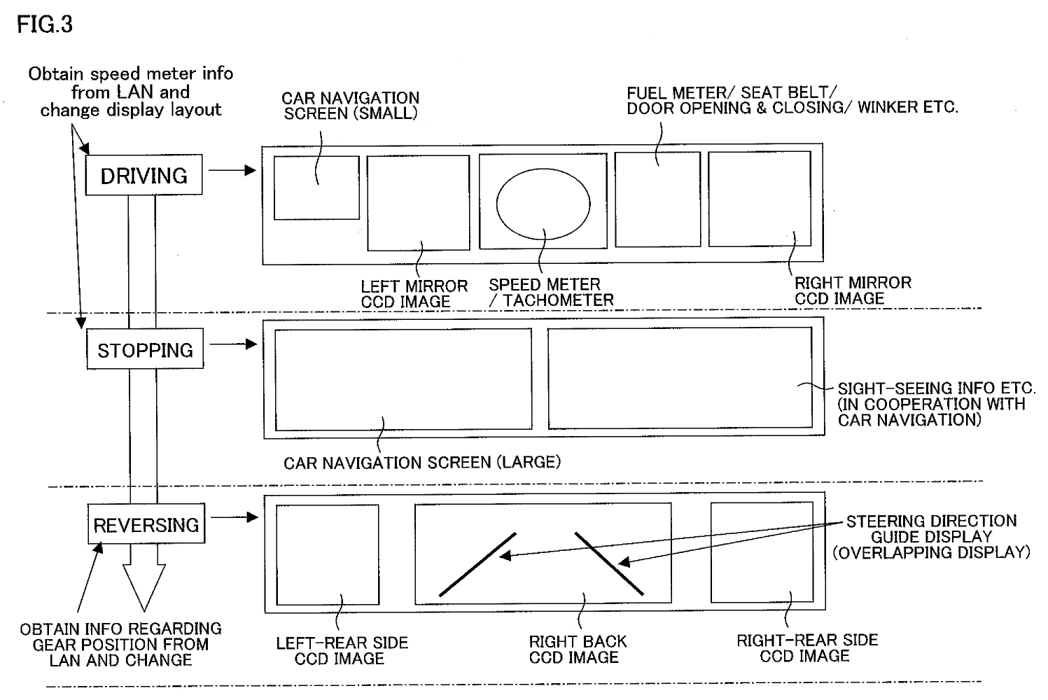

In FIG. 3, display examples of the liquid crystal panel 7 for driving, stopping, or reversing are illustrated.

To begin with, the screen display for driving is explained. As illustrated in FIG. 3, the screen is divided into, for example, 5 regions when the vehicle is driving. The leftmost region when viewed from a maneuvering person, that is, driver, is a first region displaying a car navigation screen (small), the second leftmost region is a second region displaying left mirror CCD screen, a middle region is a third region displaying a speedometer/tachometer screen, a second rightmost region is a fourth region displaying a fuel system/seat belt/door opening & closing/blinker screen, and a rightmost region is a fifth region displaying a right mirror CCD screen. Display data for displaying these screens is preferably generated as follows.

Firstly, the vehicle data from the engine-relating ECU 28a and gear-relating ECU 28b is transmitted to the vehicle system-relating micro computer 36. Further, the vehicle system-relating micro computer 36 sends the vehicle data to the amenity system-relating micro computer 39 and the safety system micro computer 42 via the display control data-transferring in-vehicle LAN 32. Moreover, the vehicle data is sent from the vehicle system-relating micro computer 36 to the DPF micro computer 9 of the display platform section 6.

In this case, the vehicle system-relating micro computer 36 transmits the received vehicle data, for example, regarding the speed and gear position, to the vehicle system-relating processor 35. From the vehicle data transmitted thereto, the vehicle system-relating processor 35 recognizes that the vehicle is driving forward. The vehicle system-relating processor 35 generates image data for images of the speedometer/tachometer screen and images of the fuel system/seat belt/door opening & closing/blinker screen, by using the vehicle system-relating GDC 34. Then, the vehicle system-relating processor 35 sends the image data to the vehicle LAN 31. Further, the vehicle system-relating processor 35 generates the screen layout data regarding the layout, for example, size, positional relationship, overlapping, etc., of the images, and the image output control data for controlling the switching-over of the images and layout. Then, the vehicle system-relating processor 35 sends the screen layout data and the image output control data to the display control data-transferring in-vehicle LAN 32.

Moreover, the amenity system-relating micro computer 39 transmits the vehicle data (for example, data regarding the speed and gear position) to the amenity system-relating processor 38. In this case, the amenity system-processor 38 recognizes from the received vehicle data that the vehicle is driving forward. The amenity system-relating processor 38 controls the amenity system-relating GDC 37 according to (i) the DVD data, which is map data inputted from the interface 46, (ii) the GPS information inputted from the SCI 47, and (iii) the vehicle data, so as to generate the image data for the navigation image. The image data is sent to the image data-transferring in-vehicle LAN 31 by the amenity system-relating GDC 37. Further, the amenity system-relating processor 38 generates the image layout data regarding the layout such as size, positional relationship, overlapping, etc., of the images, and the image output control data for controlling the switching-over of the images and layouts. The data is sent to the display control data-transferring in-vehicle LAN 32 via the amenity system-relating micro computer 39.

The safety system-relating micro computer 42 transmits the received vehicle data (data regarding the speed and the gear position) to the safety system-relating processor 41. In this case, the safety system-relating processor 41 from the received vehicle data that the vehicle is driving forward. Then, based on the data of CCDs for right and left rears inputted from the interface 48, the safety system-relating processor 41 controls the safety system-GDC 40, so as to generate the image data for the CCD images for right and left. The image data is sent to the image data-transferring in-vehicle LAN 31 by the safety system-GDC 40. Furthermore, the vehicle system-relating processor 35 generates the screen layout data regarding the layout such as sizes, positional relationship, overlapping, etc., of the images, and the image output control data for controlling the switching-over of the image and layout. The screen layout data and the image output control data are sent to the display control data-transferring in-vehicle LAN 32 via the safety system-relating micro computer 42.

The image data respectively transmitted from the vehicle system 3, amenity system 4, and the safety system 5 to the image data-transferring in-vehicle LAN 31 is inputted to the image input control section 17 via the standard image interface 19. On the other hand, the image layout data and image output control data transmitted respectively from these systems to the image data-transferring LAN 31 are inputted in the image output control section 16 and the image input control section 17 of the multiple display real-time processing circuit 8 via the DPF micro computer 9.

The image data inputted in the image input control section 17 is written in a predetermined region of the display data memory 15, according to the screen layout data inputted from the DPF micro computer 9.

The image output control section 16 reads out the image data from the display data memory 15 according to the screen layout data and the image output control data inputted from the DPF micro computer 9. Then, the image output control section 16 generates the display data for displaying the image on the liquid crystal panel 7 concurrently.

The screen layout preferably includes, for example, 5 screens when the vehicle is driving, as illustrated in FIG. 3. The leftmost region when viewed from a maneuvering person, that is, driver, is a first region displaying a car navigation screen (small), the second leftmost region is a second region displaying left mirror CCD screen, a middle region is a third region displaying a speedometer/tachometer screen, a second rightmost region is a fourth region displaying a fuel system/seat belt/door opening & closing/blinker screen, and a rightmost region is a fifth region displaying a right mirror CCD screen.

The display date generated by the image output control section 16 is outputted to the liquid crystal panel 7 via the liquid crystal image quality improving circuit 14, so as to display as illustrated in FIG. 3 under the legend “Driving”.

Moreover, when the vehicle is stopping, the display preferably includes two screens, namely, a navigation screen (large) and a sight-seeing information screen (large).

In this case, from the received vehicle data indicating that “the speed is zero”, the amenity system-relating processor 38 recognizes that the vehicle is stopping. Then, based on the DVD data (which is map data) inputted from the interface 46, and the GPS information inputted from the SCI 47, the amenity system-relating processor 38 controls the amenity system-relating GDC 37 so as to generate the image data for the navigation image and image data for the sight-seeing information image that cooperates with the navigation. Moreover, the amenity system-relating processor 38 generates the screen layout data regarding the layout such as sizes, positional relationship, overlapping, etc., of the images, and the image output control data for controlling the switching-over of the images and layouts.

The screen layout data and the image output control data thus generated are inputted into the image output control section 16 and the image input control section 17 of the multiple display real-time processing circuit 8 via the DPF micro computer 9. Then, based on these data, a car navigation screen (large) is arranged on a first region on the left side, and a sight-seeing information screen (large) is arranged on a second region on the right side when viewed from the maneuvering person, that is, the driver. Then, the car navigation screen (large) and sight-seeing information screen (large) are displayed on the liquid crystal panel 7 of the liquid crystal image quality improving circuit 14.

When the vehicle is reversing, the display preferably includes three screens, namely, a left-rear side CCD image (medium), front CCD image (large), and right-rear side CCD image.

That is, the safety system-relating processor 41 recognizes from the received vehicle data regarding such as the reversing gear position, speed, etc., that the vehicle is reversing. Then, based on the data from the respective CCDs inputted from the interface 48, the safety system-relating processor 41 controls the safety system-relating GDC 40 so as to generate the image data for the CCD images such as the left-rear side CCD image, front CCD image, right-rear side CCD image, reversing maneuver guiding image, etc. Moreover, the safety system-relating processor 41 generates the screen layout data regarding the layout such as sizes, positional relationship, overlapping, etc. of the images, and the image output control data for controlling the switching-over of the image and layout.

In this display state, the display preferably includes three screens when the vehicle is reversing. That is, when viewed from the maneuvering person, that is, driver, the left-rear side CCD image (medium) is arranged on the first region being positioned leftmost, the front CCD screen (large) is arranged on the second region being positioned middle, and the right-rear side CCD screen (medium) is arranged on the third region being positioned rightmost.

The above explanation describes a case where the processors of the various systems such as the vehicle system-relating processor 35, amenity system-relating processor 38, and safety system-relating processor 41, generates the screen layout data and the image output control data, and the image is laid out according to the screen layout data and the image output control data.

However, there is a case where the screen layout data and the image output control data generated by the vehicle system-relating processor 35, amenity system-relating processor 38, and safety system-relating processor 41 should be changed according to a customizing request as to screen layout, or according to an addition of a new option.

In this case, the example explained above requires that the processes of the vehicle system-relating processor 35, amenity system-relating processor 38, and safety system-relating processor 41 should be changed according to the customizing request or the option addition. Such changes in plural processes are complicated.

Such complicated changes can be avoided by arranging such that a screen layout table (not illustrated) is provided in the image output control section 16, so that the image layout data and image output control data are generated by the display platform section 6.

In this case, the screen layout table is arranged such that a look-up table is provided per image, the look-up table predetermining association of (i) the control data (such as vehicle data etc. encompassing the data regarding the speed and gear position transmitted via the display control data-transferring in-vehicle LAN 32) and (ii) the screen layout data and image output control data.

As a result, the vehicle data is transmitted to the multiple display real-time processing circuit 8 via the DPF micro computer 9. Based on the control data, the screen layout table is looked up, so as to find the screen layout data and the image output control data associated with the control data. After that, the display data for displaying the images on the liquid crystal panel 7 concurrently is generated in the same way as in the above example.

An interface is provided to update the screen layout table externally. With this, the screen layout table can be updated easily. Thus, even if a customizing request or option addition is made, such a customizing request or option addition can be dealt with simply by updating the screen layout table. This can avoid complicated processing.

The interface for updating the screen layout table may be a device for reading a recording medium such as a memory card or hard disc, or a system which does not use a recording medium, such as a system which downloads via the Internet.

In the above example, the image data is transmitted from the respective GDCs via the image data-transferring in-vehicle LAN 31, and the layout data is transmitted from the respective micro computers via the display control data-transferring in-vehicle LAN 32. In its modification, the image data is transmitted from the respective GDCs via the image data-transferring in-vehicle LAN 31, and the control data is transmitted from the respective micro computers via the display control data-transferring in-vehicle LAN 32. In such a case where the systems are connected with each other via plural transferring pathways, it is preferable to use standardized connectors of one type. This makes it possible to connect the systems with each other by using only a single connecting device. This makes it easy to connect the systems with each other, and eliminates need of providing plural connecting devices, thereby reducing cost and making it easy to recycle, that is, reducing wastes.

Incidentally, in the display system according to the present preferred embodiment, there is a case where it is desired to display an identical display on the front liquid crystal panel 7a and the rear liquid crystal panel 7b, and there is a case where it is desired to display different displays on the front liquid crystal panel 7a and the rear liquid crystal panel 7b. In the present preferred embodiment, as illustrated in FIG. 1, the judging section 51 and the look-up table (LUT) 52 (screen combination pattern storing section) of all-panel control section 50 can control the display appropriately. This control is described below.

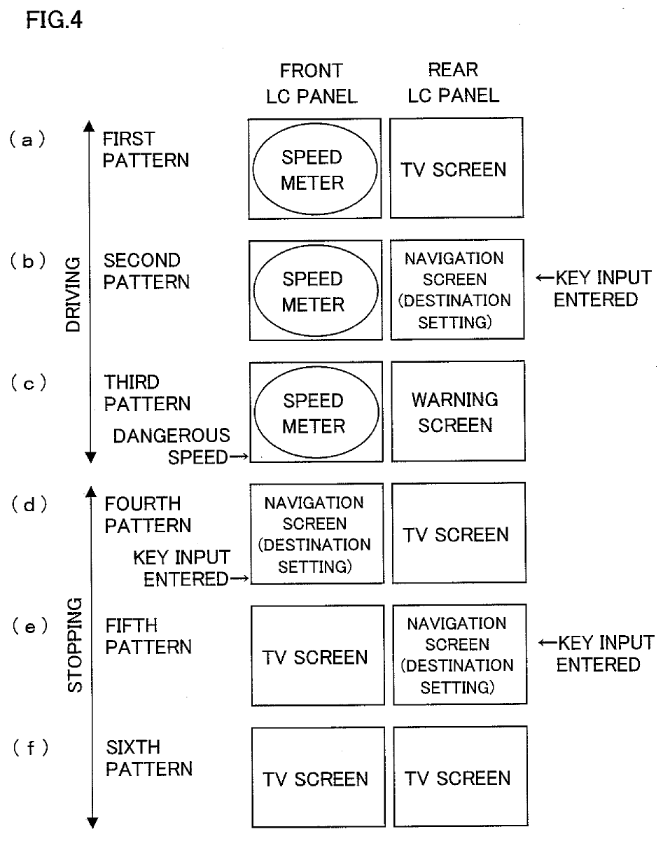

Firstly, based on the control information transmitted from the in-vehicle network 2 including the image data-transferring in-vehicle LAN 31, the display control data-transferring in-vehicle LAN 32, and the vehicle data-transferring in-vehicle LAN 21, the judging section 51 judges whether the automobile is currently driving, stopping or reversing. Based on the judging, the layout data stored in the look-up table (LUT) 52 is specified. The look-up table (LUT) 52, for instance, stores layout data as illustrated in FIG. 4 under legends (a) to (f). The layout data in FIG. 4 under legends (a) to (f) are information indicating the layout of each screen of the front liquid crystal panel 7a and the rear liquid crystal panel 7b, and have at least information regarding types, sizes, and positions of the images to be displayed.

Moreover, based on the specified layout data, the judging section 51 judges whether the image data transmitted from the in-vehicle network 2 is image data to be outputted on the front liquid crystal panel 7a by the display platform section 6 (first control circuit 6a as the display screen control section) of the front liquid crystal panel 7a, or image data to be outputted on the rear liquid crystal panel 7b by the display platform section 6 (second control circuit 6b as the display screen control section) of the rear liquid crystal panel 7b.

More specifically, the layout data for use in the first control circuit 6a (hereinafter, this layout data is referred to as “first layout data”), and layout data for use in the second control circuit 6b (hereinafter, this layout data is referred to as “second layout data”) are respectively referred to find out types of images thereof. Image data of the types of the images included in the first layout data is outputted to the first control circuit 6a, whereas images of the types of the images included in the second layout data is outputted to the second control circuit 6b.

The first control circuit 6a generates a first composite image, based on the image data and the first layout data outputted from the judging section 51. Then the first control circuit 6a displays the first composite image on the front liquid crystal panel 7a. On the other hand, the second control circuit 6b generates a second composite image, based on the image data and the second layout data outputted from the judging section 51. Then the second control circuit 6b displays the second composite image on the rear liquid crystal panel 7b.

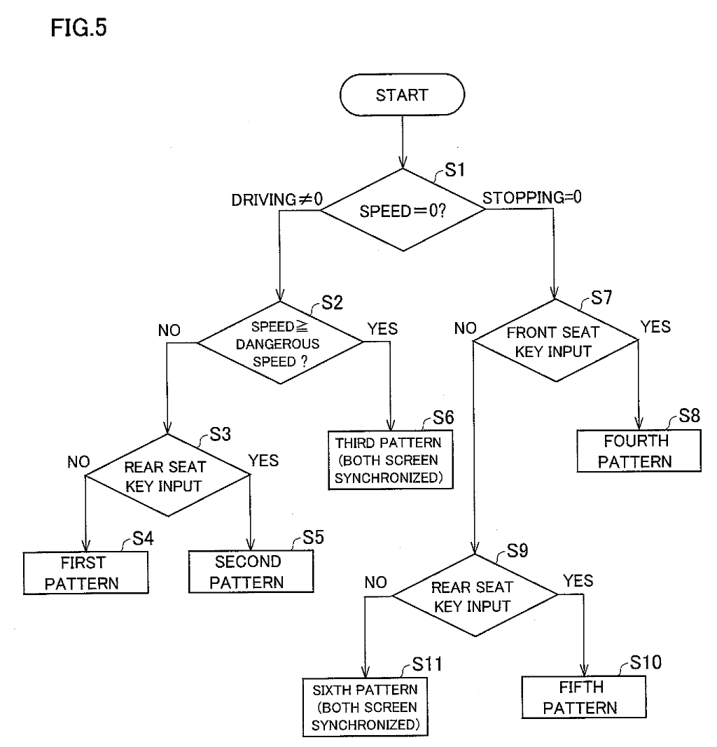

The display control operation of the display system of the above arrangement is more specifically explained below referring to the flowchart of FIG. 5 and FIG. 4.

Firstly, as illustrated in FIG. 5, the judging section 51 judges the current state of the vehicle as to whether the speed is 0 or not, based on the control information transmitted to the judging section 51 via the in-vehicle network 2 including the image data-transferring in-vehicle LAN 31, the display control data-transferring in-vehicle LAN 32, and the vehicle data-transferring LAN 21 (S1). If the vehicle is driving, the judging section further judges whether the speed is at a dangerous speed or higher (S2). If the speed is lower than the dangerous speed, the judging section judges whether a rear seat key input K2 is inputted or not (S3). If no rear seat key input K2 is inputted, a first pattern illustrated under legend (a) in FIG. 4 is displayed (S4). That is, for example, the speedometer is displayed on the front liquid crystal panel 7a, while the TV screen is displayed on the rear liquid crystal panel 7b.

If a rear seat key input K2 is inputted at S3, a second pattern illustrated under legend (b) in FIG. 4 is displayed (S5). That is, for example, the speedometer is displayed on the front liquid crystal panel 7a, and the navigation screen such as destination setting etc., is displayed on the rear liquid crystal panel 7b.

Furthermore, at S2, if the speed is over the dangerous speed, a third pattern in which both the screens are synchronized, as illustrated under legend (c) in FIG. 4, is displayed (S6). That is, for example, the speedometer is displayed on the front liquid crystal panel 7a, while the warning screen is displayed on the rear liquid crystal panel 7b. By this, a passenger in the rear seat is also notified that the speed is higher than the dangerous speed. The warning screen may not be a whole screen display, for example, and may be letters displayed at a lower portion of the navigation screen.

On the other hand, if the vehicle is stopping at S1, the judging section 51 judges whether a front seat key input K1 is inputted or not (S7). If a front seat key input K1 is inputted, a fourth pattern illustrated under legend (d) in FIG. 4 is displayed (S8). That is, for example, the navigation screen such as destination setting, etc., is displayed on the front liquid crystal panel 7a, and the TV screen is displayed on the rear liquid crystal panel 7b.

Moreover, if no front seat key input K1 is inputted at S7, the judging section further judges whether a rear seat key input K2 is inputted or not (S9). If a rear seat key input K2 is inputted, a fifth pattern illustrated under legend (e) in FIG. 4 is displayed (S10). That is, for example, the TV screen is displayed on the front liquid crystal panel 7a, while the navigation screen such as destination setting, etc., is displayed on the rear liquid crystal panel 7b.

Furthermore, if no rear seat key input K2 is inputted at S9, a sixth pattern illustrated under legend (f) in FIG. 4 is displayed (S11). For example, the TV screen is displayed on the front liquid crystal panel 7a, while the TV screen is also displayed on the rear liquid crystal panel 7b.

That is, the screen settings of the front liquid crystal panel 7a and the rear liquid crystal panel 7b are as follows during the driving. That is, if the front seat key input K1 and the rear seat key input K2 are not entered, the front liquid crystal panel 7a displays the speedometer thereon, while the rear liquid crystal panel 7b displays the TV screen thereon, as a standard. If a key input is entered at the rear seat, only the rear liquid crystal panel 7b changes to the navigation screen. Further, if the speed reaches the dangerous speed during the driving, the warning display is provided on both the screens in synchronism regardless of the front seat key input K1 and the rear seat key input K2.

On the other hand, the screen settings of the front liquid crystal panel 7a and the rear liquid crystal panel 7b are as follows during the stopping. That is, if the front seat key input K1 and the rear seat key input K2 are not entered, the front liquid crystal panel 7a and the rear liquid crystal panel 7b both display the TV screen thereon, as a standard. If a front seat key input K1 is entered at the front seat, only the front liquid crystal panel 7a changes to the navigation screen. Further, if a rear seat key input K2 is entered at the rear seat, only the rear liquid crystal panel 7b changes to the navigation screen.

As a result, the display system and the display control method of the display system according to the present preferred embodiment are different from the conventional display systems in that the judging section 51 is provided, which looks up the layout data of the look-up table (LUT), and outputs the image data to appropriate destinations respectively. This eliminates the need for plural control sections in the display system in which plural front and rear liquid crystal panels 7a and 7b are provided. Thereby, the production cost is reduced. This arrangement also allows the plural liquid crystal panels to display in cooperation.

Finally, in the present preferred embodiment, the display control of the display system is carried out by the display system as illustrated in FIG. 1. Here, the elements or sections of the display system may be constituted by a hardware logic or realized by software by using a CPU as follows.

That is, the display system may include CPU (central processing unit) for executing commands of a control program realizing the functions, a ROM (read only memory) in which the program is stored, a RAM (random access memory) for expanding the program therein, and a recording device (recording medium) or the like such as a memory for storing the program and various data therein.

Various advantages of the present invention can also be achieved by mounting to the display system a computer-readable recording device (storage medium) containing program code (executable program, intermediate code program, or source program) of a data display program of the display system, which data display program is software realizing the aforementioned functions, in order for the computer (or CPU, MPU, LSI capable of executing the program on hardware) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The display system may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a carrier wave or data signal transmission in which the program code is embodied electronically.

As described above, the display system and the display control method of the display system according to the present preferred embodiment are for use in a maneuverable movable product (such as a vehicle) and for displaying plural pieces of information respectively on those screens of the front and rear display panels 7a and 7b which respectively correspond to the plural pieces of information, wherein information regarding the movable product is included among the plural pieces of information. Therefore, the present preferred embodiment is arranged such that the front liquid crystal 7a and the rear liquid crystal panel 7b exist independently as a front display panel provided at a front portion of the vehicle and a rear display panel provided at a rear portion of the vehicle.

Moreover, the present preferred embodiment is arranged such that the front liquid crystal 7a and the rear liquid crystal panel 7b are capable of displaying at least one screen. Therefore, the front liquid crystal 7a and the rear liquid crystal panel 7b display one screen only or plural screens. Thus, for example, plural screens, for example, a screen regarding a speed and a navigation screen, can be displayed on the one front liquid crystal panel 7a. Meanwhile, for example, only TV screen is displayed on the rear liquid crystal panel 7b.

Moreover, based on plural pieces of information among which the information regarding the vehicle is included, the all-panel control section 50 provided singly selects which screen is to be displayed on the front liquid crystal panel 7a and rear liquid crystal panel 7b. The first control circuit 6a and second control circuit 6b generate the display data of the screens to be displayed on the front liquid crystal panel 7a and the rear liquid crystal panel 7b.

As a result, the all-panel control section 50 provided singly can control the display data of each screen of the first control circuit 6a and the second control circuit 6b.

Therefore, it is possible to provide a display system and a display control method of the display system, each of which allows integral control of screen displays on the front liquid crystal panel 7a and the rear liquid crystal panel 7b, which are provided in a vehicle as plural liquid crystal panels.

Moreover, the cost is reduced compared with the conventional art, with the arrangement in which the integral control of screen displays on the front liquid crystal panel 7a and the rear liquid crystal panel 7b is performed by the all-panel control section 50 provided singly.

Moreover, the display system according to the present preferred embodiment is arranged such that the judging section 51 judges the types of the plural pieces of the information among which the information regarding the vehicle is included. Examples of the types of the information are: speedometer information, information regarding analog component type TV/digital TV (SDTV (Single Definition TV))/navigation, etc., information regarding CCD camera/analog composite type TV, etc., front seat key input information, and rear seat key input information.

The look-up table (LUT) 52 stores the combinations patterns of the screens for the front liquid crystal panel 7a and the rear liquid crystal panel 7b. Based on the stored combinations patterns of the screens for the front liquid crystal panel 7a and the rear liquid crystal panel 7b, the judging section 51 causes the first control circuit 6a and the second control circuit 6b to perform display control for at least one screen on the front liquid crystal panel 7a and the rear liquid crystal panel 7b.

As a result, the judging section 51 and the look-up table (LUT) 52 can easily attain integral control of the screen display of the plural liquid crystal panels, that is, the front liquid crystal panel 7a and the rear liquid crystal panel 7b.

Moreover, the display system according to the present preferred embodiment is arranged such that the look-up table (LUT) 52 contains the combination patterns of the screens to display concurrently plural pieces of information (among which the information regarding the vehicle is included) on the front liquid crystal panel 7a and the rear liquid crystal panel 7b. With this, it is possible to display the screens of content on the front liquid crystal panel 7a and the rear liquid crystal panel 7b.

Moreover, the display system according to the present preferred embodiment is arranged such that as the patterns of the combinations of the screens of the front liquid crystal panel 7a and the rear liquid crystal panel 7b, the look-up table (LUT) 52 stores patterns regarding types, sizes, and locations of the screens of the front liquid crystal panel 7a and the rear liquid crystal panel 7b. With this, it is possible to display the screens different in type, size, and location on the front liquid crystal panel 7a and the rear liquid crystal panel 7b.

Moreover, the display system according to the present preferred embodiment is arranged such that the maneuverable movable product is a vehicle. It is possible to provide a display system, which allows integral control of screen displays on the front liquid crystal panel 7a and the rear liquid crystal panel 7b, which are provided in a vehicle as plural liquid crystal panels.

Moreover, the display system according to the present preferred embodiment is arranged such that the information regarding the vehicle is vehicle information.

With this, the vehicle information, which is essential information for the vehicle, can be displayed on at least one screen at least on the front liquid crystal panel 7a.

Moreover, the display system according to the present preferred embodiment is arranged such that multimedia information is included among the plural pieces of information among which the information regarding the vehicle is included. With this, the multimedia information can be displayed on at least one screen on at least on the front liquid crystal panel 7a or the rear liquid crystal panel 7b.

Moreover, the display system according to the present preferred embodiment is arranged such that amenity information and safety information are included among the multimedia information, wherein the amenity information is additional information for supporting a maneuver of the movable product and may be map information or other suitable information, and safety information is information for improving safety of the maneuver and may be information obtained from a blind spot sensor or the like information.

The amenity information such as TV and navigation, for example, and images for safe driving, such as images of the front CCD camera, rear CCD camera, etc., has been displayed recently in vehicles. With the arrangement described above, such amenity information and information regarding safety can be displayed on at least one screen at least on the front liquid crystal panel 7a.

Moreover, in the present preferred embodiment, the display system can be realized by realizing each element or section of the display system by using a computer. Further, with a data display program read from a recording medium, the display system can be realized by using a computer such as LSI, etc., which can execute the program on hardware.

The present invention being thus described, it will be obvious that the same may be varied in many ways. Such variations are not to be regarded as a departure from the spirit and scope of the invention, and all such modifications as would be understood or recognized by one skilled in the art are intended to be included within the scope of the following claims.

The present invention is applicable to a display system and a display control method of the display system, which are for use in a maneuverable movable product and for displaying plural pieces of information respectively on those screens of plural display panels which respectively correspond to the plural pieces of information, wherein information regarding the movable product is included among the plural pieces of information. The maneuverable movable product may be a vehicle such as an automobile, a train, an airplane, a vessel, for example, or other suitable vehicles or transportation equipment.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12: A display system for use in a maneuverable movable product and for displaying plural pieces of information respectively on screens of plural display panels which respectively correspond to the plural pieces of information, wherein information regarding the movable product is included among the plural pieces of information, wherein each display panel is capable of displaying at least one screen, the display system comprising:
a display screen control section provided for each display panel and arranged to generate display data of the at least one screen of the display panel; and
a display selecting section arranged to select screens to be displayed respectively on the display panels, the selecting being carried out based on the plural pieces of information among which the information regarding the movable product is included.

13: The display system as set forth in claim 12, wherein the display selecting section includes:
a judging section arranged to judge types of the plural pieces of information, among which the information regarding the moving body is included, and to cause the display screen control circuits to display and control the at least one screen on the respective display panels; and
a screen combination pattern storing section arranged to store patterns of combinations of the screens of the display panels.

14: The display system as set forth in claim 13, wherein the screen combination pattern storing section stores a pattern for displaying plural pieces of information on screens of the display panels concurrently, wherein the information regarding the movable product is included among the plural pieces of information.

15: The display system as set forth in claim 13, wherein as the patterns of the combinations of the screens of the display panels, the screen combination pattern storing section stores patterns regarding types, sizes, and locations of the screens of the display panels.

16: The display system as set forth in claim 12, wherein the maneuverable movable product is a vehicle.

17: The display system as set forth in claim 16, wherein the information regarding the movable product is vehicle information.

18: The display system as set forth in claim 16, wherein multimedia information is included among the plural pieces of information among which the information regarding the movable product is included.

19: The display system as set forth in claim 18, wherein amenity information and safety information are included among the multimedia information, wherein the amenity information is additional information used to support a maneuver of the movable product and may be map information or other information, and safety information is information used to improve safety of the maneuver and may be information obtained from a blind spot sensor or other information.

20: A display control method for a display system for use in a maneuverable movable product and for displaying plural pieces of information respectively on screens of plural display panels which respectively correspond to the plural pieces of information, wherein information regarding the movable product is included among the plural pieces of information, the display control method comprising the steps of:
causing the display panels each to display at least one screen thereon;
selecting the at least one screen to be displayed respectively on each display panel, the selecting being carried out based on plural pieces of information among which the information regarding the movable product is included; and
controlling the screens of the display panels including generating display data of the at least one screen of each display panel.

21: A computer readable medium storing a computer program with a program code for performing, when the computer program runs on a computer, the display control method as set forth in claim 20.
